(19) United States
(12) Patent Application Publication
(10) Pub. No.: US 2015/0006434 A1
(43) Pub. Date: Jan. 1, 2015

(54) RULES-BASED ESCROW SYSTEMS AND METHODS

(71) Applicant: First American Financial Corporation, Santa Ana, CA (US)

(72) Inventor: CHARLES NIETHOLD, Santa Ana, CA (US)

(73) Assignee: First American Financial Corporation, Santa Ana, CA (US)

(21) Appl. No.: 13/929,676

(22) Filed: Jun. 27, 2013

(51) Int. Cl. G06Q 40/06

(52) U.S. Cl. CPC G06Q 40/06
USPC 705/36 R

(57) ABSTRACT

A system and method for providing a self-service process to consumers such as for example, borrowers in the real estate market. An escrow module can be configured to execute rules to manage and guide a consumer through a self-service escrow process. For example, the escrow module can be configured to provide information to the borrow, prompt the borrower for needed input to begin and carry out a financing process, interface with the title company and other third-party providers to coordinate the financing process, check and maintain the status and progress of the escrow process as it is being carried out, verify that all items are complete for the financing, and coordinate follow up for missing or open items.

### TECHNICAL FIELD

The disclosed technology relates generally to escrow systems, and more particularly, some embodiments relate to systems and methods for providing a self-service, rules-based escrow system and process.

### DESCRIPTION OF THE RELATED ART

When a buyer and seller enter into a sales contract for real property such as, for example, a Real Estate Purchase Agreement, they often open escrow. For the typical escrow process for the purchase of real property, the escrow company, or agent, holds the executed deed any purchase monies deposited into escrow until such time as all of the purchase and sale conditions have been met. This ensures that neither party has access to the other party's property until all parties have performed and the deal can be finalized. Escrow can also be used for real-estate refinance transactions.

The conventional escrow process is managed by an escrow officer. The escrow officer processes the escrow in accordance with the escrow instructions. As noted above, when all conditions required in the escrow are met, the escrow is “closed” the deed is delivered to the buyer (or his or her lender, where a loan is used to purchase the property) and the funds are delivered to the seller (or the seller's lender, where the loan is secured by the property). Although escrows are generally similar, they are all slightly different depending on the circumstances of the purchase or refinance transaction.

The escrow officer is expected to follow the written escrow instructions given by the principals and parties to the transaction; handles funds, documents and other escrow items in accordance with those instructions; pay expenses from the escrowed funds if authorized; and disburse the funds to the designated parties and principals (i.e., close the escrow) only when all conditions have been met.

### BRIEF SUMMARY OF EMBODIMENTS

According to various embodiments of the disclosed technology, a system and method for providing a self-service escrow process to consumers is provided in one embodiment, an escrow module is provided that can be configured to execute rules to manage and guide a consumer through a self-service escrow process. As explained more fully below, in various embodiments the escrow module can be configured to provide information to the borrower, prompt the borrower for needed input to begin and carry out a financing process, interface with the title company and other third-party providers to coordinate the financing process, check and maintain the status and progress of the escrow process as it is being carried out, verify that all items are complete for the financing, and coordinate follow up for missing or open items.

According to one embodiment of the disclosed technology, a computer system having a processor and memory is provided that is configured to execute certain instructions. When executed, the system provides self-service escrow to a borrower. Various embodiments of the invention provide a user interface configured to allow a borrower to input information used for the escrow process. The user interface can be generally configured to allow the borrower to initiate the self-service escrow process, and enter information requested information. Embodiments may also include configurations providing the borrower with a list of information, documentation and other data items needed to proceed through the borrower-driven self-service escrow process.

Preferred embodiments are generally configured to receive the data items requested from the borrower and checking them against predetermined parameters to assess whether or not the data items submitted by the borrower are acceptable. Further embodiments of present invention may also include verifying the accuracy of the various information received in accordance with set standards (e.g. set by the lender, escrow company, etc.) Generally, verification will involve various third-parties to meet the verification standards required by the lender(s). In still further embodiments of the present invention, the system will be configured to track the status of requested data items, flag incomplete or unacceptable data items, and remind the necessary parties (including the borrower) of outstanding data items (e.g. items that are incomplete or unacceptable. In various embodiments, one or more requests or reminders can be sent to the appropriate parties instructing them to complete, update, or verify certain data items—until such time when data items are complete. In further embodiments, the system can be configured to send a status report to some or all of the parties, detailing the status of data items. This can be particularly useful so that all parties can know what items might be holding up the process, if it is delayed for any reason. The system can further be configured to monitor and determine when all escrow items have been completed, and then inform the escrow company and the lender (and any others requested) that the loan can proceed to closing.

In still other embodiments, the system may be configured to assign the borrower to a lender, suggest one or more lenders using the information received, or allow the user to choose a tender. Another embodiment of the systems and methods described herein may tailor the data items requested from the borrower based on the predetermined requirements by the particular lender(s). Such embodiments may also be configured to flag or mark the data items received from the borrower to designate status information. Such status information about the data items can be provided to the borrower or any other party requested.

In still further embodiments, the system may be configured to prompt the borrower to order insurance for a property being used to secure the loan. Such insurance may be a requirement to proceed through the escrow process (e.g. as with hazard insurance for some lenders), or it may be offered as an optional feature as a matter of course (e.g. liability insurance). The borrower may also be provided with a list of insurance providers through whom the borrower may procure insurance. The system may also be configured to provide the borrower with the minimum insurance requirements stipulated by a lender. A borrower already having the required insurance may, in some embodiments, be provided with instructions on how and what to submit to the system to provide sufficient proof/certification of such insurance (e.g. instructions on scanning, faxing or emailing certain documentation), the preferred embodiment being configured to receive such proof/certification of insurance (e.g. in electronic format).

Generally, when a transaction involves new property, the borrower will need new insurance coverage. The system may also be configured, in some embodiments, to prompt the borrower to secure various other insurance coverage that may be combined with the selected policy or policies covering the property. Accordingly, it may also update and send status reports concerning insurance selections and/or modifications, including indications designating the effective dates of insurance coverage. And, it may be configured to accept from the user proof of the insurance obtained.

In yet further embodiments, the system may be configured to analyze the information acquired from the borrower, provide an estimate of the likely terms of the loan arrangement, and provide some prediction of what terms the borrower might be able to obtain if they proceed. In some embodiments, this prediction will be specific to a particular lender or set of lenders, or, multiple predictions may be provided based on lender-specific information and/or trends. In some embodiments, the borrower may be able to change their selected lender based on the predictions provided. Other configurations provided may also provide the borrower the opportunity to transfer some of their already-submitted information into a new self-service escrow session established with the newly selected lender.

In yet further embodiments, the system may be configured to provide the borrower with a listing of title companies that may perform title services in conjunction with the property of interest. Furthermore, some embodiments may open sub-escrow order and title order, and submit a request to a title company including the sub-escrow order and the title order. In general, such preferred embodiments generally also comprise receiving information back from the title company with a determination as to whether or not the submitted request will qualify for the self-service escrow process. Various embodiments incorporating this feature may also generally comprise notifying the lender and/or other designated parties that they may access the received information to verify that the received information meets the lender's standards. Once each of the required documents is determined to be adequate, including though verification by the lender, some embodiments prompt the borrower to select a document signing service for executing the final loan documents.

After the final documents have been signed, various configurations can provide the escrow documents to the borrower for review, and prompt the borrower to count and enter the number of pages of a deed document. The number of pages is then received and used to automatically calculate a recording fee based on the number of pages of the deed document. Notification is generally received by the system, in some embodiments, with an indication of whether or not the loan has been funded and whether or not escrow has recorded the note at the appropriate county office. The system may then flag the transaction and as complete.

The system can be configured to receive confirmation of the final title insurance policy, if there is one, and close the file after checking to ensure that necessary items are completed. In various embodiments, the system can be configured to compile final loan documents (including insurance, and other documents as needed) into a complete packet—sent or stored electronically, or printed as a hard copy—for the borrower and/or lender involved in the transaction. Further embodiments can comprise creating the final HUD-1 statement and sending it to the lender.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a high-level block diagram illustrating an escrow system in an example environment in accordance with one embodiment of the technology described herein.

FIG. 2 is a diagram illustrating an example process for a self-service escrow in accordance with one embodiment of the technology described herein.

FIG. 3 is an operational flow diagram illustrating an example process for completing the loan documents in accordance with one embodiment of the technology described herein.

FIG. 4 is an operational flow diagram illustrating an example process for insurance verification in accordance with one embodiment of the technology described herein.

FIG. 5 is an operational flow diagram illustrating am example process for completing escrow documents in accordance with one embodiment of the technology described herein.

FIG. 6 is an operational flow diagram illustrating an example process for managing preparation and delivery of loan documents to the lender in accordance with one embodiment of the technology described herein.

FIG. 7 is an operational flow diagram illustrating an example process for completing the refinance process in accordance with one embodiment of the technology described herein.

FIG. 8 illustrates an example computing module that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward a system and method for providing a self-service escrow process to consumers such as for example, borrowers in the real estate market. In one embodiment, an escrow module is provided that can be configured to execute rules to manage and guide a consumer through a self-service escrow process. As explained more fully below, in various embodiments the escrow module can be configured to provide information to the borrower, prompt the borrower for needed input to begin and carry out a financing process, interface with the title company and other third-party providers to coordinate the financing process, check and maintain the status and progress of the escrow process as it is being carried out, verify that all items are complete for the financing, and coordinate follow up for missing or open items.

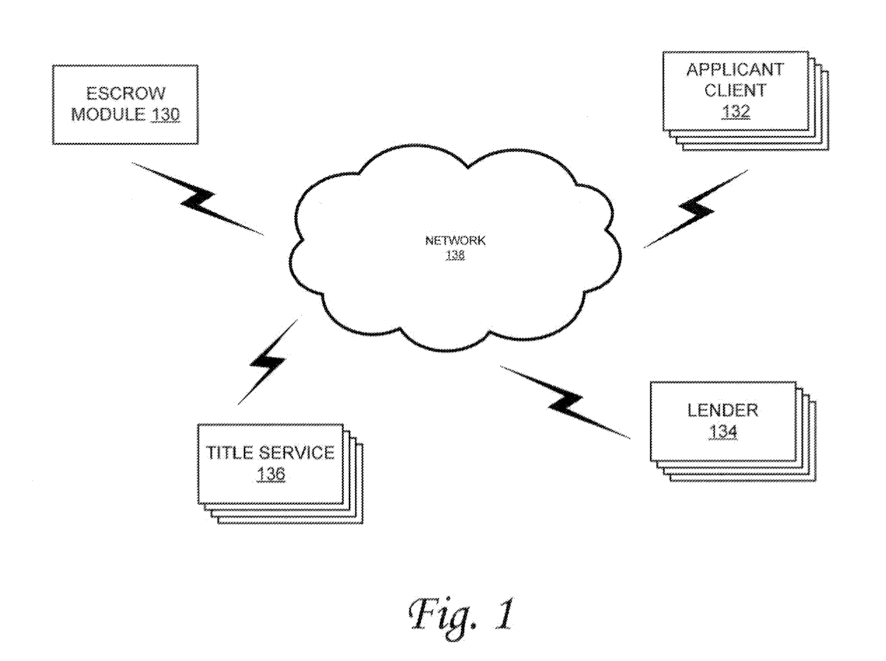

FIG. 1 is a high-level block diagram illustrating an escrow system in an example environment in accordance with one embodiment of the technology described herein. As can be seen in the example of FIG. 1, an escrow module is provided and is in communicative contact (via network 138) with loan applicants 132, lending institutions 134 and title and escrow companies 136. Although the components in this environment are illustrated as communicating via network 138, other communication paths or channels, whether direct or indirect, can be used for communications.

Escrow module 130 can include one or more processing systems having software or other program code configured to perform features and functionality described herein. Although illustrated as a discrete module for convenience, escrow module can be implemented as a stand-alone unit, or it can be distributed across other entities or instrumentalities. For example, portions of escrow module 130 can be implemented as applications or other code running on the applicants' computing systems.

Applicant client 132 can include a client computing system used by a loan applicant to apply for a loan. Accordingly, applicant 132 can comprise an application or other code running on a computing device such as, for example, a tablet, smartphone, laptop or desktop computer, or other like computing device. Lenders 134 can include the various lending institutions through which an applicant might obtain financing. This financing can include, for example, financing for the purchase or refinance of real property. Title service 136 can include various title companies that applicants might use to perform title services in conjunction with the real-property financing. One example of a title service 136 is the title service offered by First American Title Insurance Company.

Although not illustrated in FIG. 1, other entities can be included and interfaced with such as, for example, insurers, document signing services, credit reporting agencies, and so on.

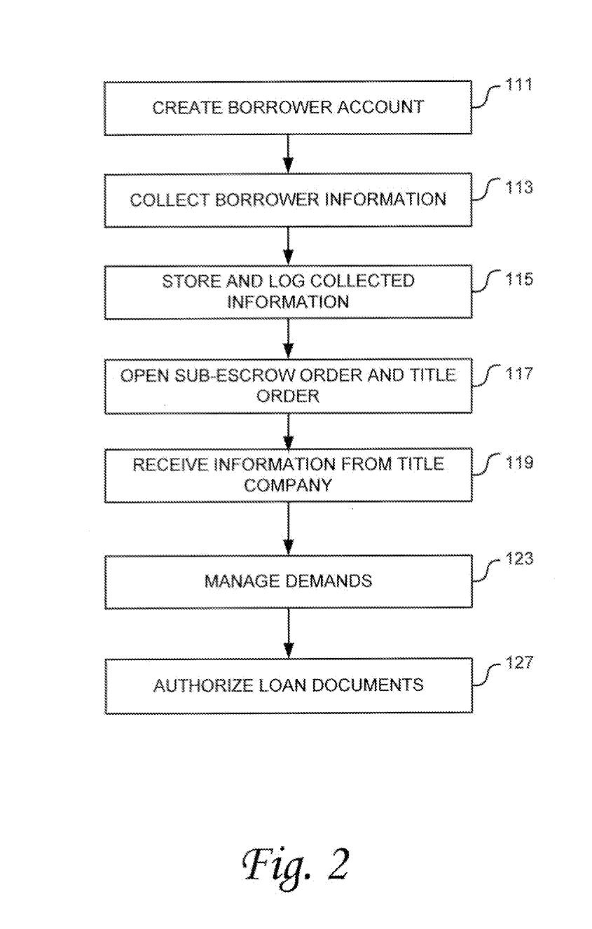

FIG. 2 is a diagram illustrating an example process for a self-service escrow in accordance with one embodiment of the technology described herein. For ease of discussion, the example operations in this document are described in terms of exemplary refinancing process wherein a user desires refinance an existing loan on his or her property. As will be apparent to one of ordinary skill in the art after reading this discussion, the systems and methods described herein can equally be applied to purchase money loans and other escrow operations.

Referring now to FIG. 2, at operation 111 a user account is created. For example, in some instances, to user may be given the opportunity to sign up for the service (e.g., to become a member) via a website or other like application. Through this process, the user can be given the opportunity to create a user ID and a password such that the user can be identified throughout the process and be given access to the information in his or her file.

At operation 113, additional user information can be collected about the user, and about the property the user is seeking to refinance. For example, the information collected can include information such as the current insurance agent, policy number, insurance broker, insurance contact information, and other insurance-related information about the current insurance on the subject property; and home warranty information, if any; current loan information including, for example, current lender, loan balance, interest rate; approximate market value (e.g., as may be estimated by the borrower); preferred lenders for the new loan; and so on. Additional and/or other information can also be collected at this time. In one embodiment, the user is prompted to enter this information on his or her laptop, tablet, or other client computing device, and the entered information is provided to the escrow module. This can be done, for example, by providing forms via a web agent or a downloaded application for the user to fill out and provide the requested information.

At operation 115, when the information collected from the user is stored for use during the refinancing process. The information can be stored locally, for example, have local storage associated with the escrow module alternatively, the information can be stored remotely at a server or other location including, for example, cloud-based servers. The escrow module can further be configured to maintain a record of the information received as well as information items that are still outstanding from the borrower, and reminders can be sent to the borrower to provide any remaining outstanding items. Alternatively, actions can be taken to obtain this information from other sources. Additionally, some items can be flagged as requiring verification from third-party sources. For example, existing loan balances, the existing of 1st and 2nd loans, can be verified through public records as well as current lenders. Accordingly, unverified items can remain flagged as unverified until such time as the verification is complete. In the meantime, however, unverified items might still be usable by the system (or entities having access to the system) to predict or estimate data pertinent to the loan such as, for example, loan-to-value estimates, interest rates, and so on. Such estimates can be provided to the borrower as an idea of what terms they might be able to obtain if they were to proceed with the refinance.

At operation 117 the escrow module opens a sub-escrow order and a title order. In some embodiments, as a result of this operation a request is sent to the title company including a title order and a sub-escrow order. In various embodiments, this request is intended to initiate a standard title reporting process performed by the title company. In this process, for example, the title company runs a title report, reviews a title report, and determines whether the property qualifies for the self-service escrow process. For example, the title company can check for information that might render the transaction unsuitable for the self-service escrow process. Such information can include facts or circumstances that would render the transaction unworkable for an automated process, or otherwise indicate that the level of risk associated with the transaction is too high for the automated process. The types of information the title company can check for when making this analysis can include, for example, judgments liens, child support, or other outstanding debt or involuntary liens that may affect the refinance, or that may require additional processing steps that are not suitable for the automated self-service process. Other circumstances that may indicate that a given transaction is not suitable for the automated self-service process might include marital status (e.g., the property is an asset in a divorce situation), death, number of parties involved in the transaction, and so on. Additionally, the information provided to the title company with the orders can include information provided by the borrower to the escrow module. Accordingly, the title company can also check to determine whether there are any discrepancies between what was reported by the borrower and what was uncovered by the title company. Such discrepancies may raise a flag precluding the transaction from qualifying for the self-service escrow process.

The information obtained by the title company is reported back to and received by the escrow module at operation 119. For example, in this circumstance where the transaction will not qualify for the self-service escrow process, the title company can provide information to the escrow module indicating that the transaction will not qualify and provide the reasons for that determination. In this event, a standard order, can be opened, and the manual escrow process utilized. Where the transaction does qualify, information such as, for example, the title report can be sent from the title company to the escrow module. In other embodiments, the title report can be sent directly to the consumer from the title company. With a title report process, the lender can begin drawing loan documents so they can be prepared, finalize, and sent to the customer. Accordingly, the title company may also send the title report to the lender so that this process can begin. In some embodiments, the title company provides information to the escrow module so the escrow module can keep track of received title reports. The escrow module can further be configured to determine whether the appropriate parties received the title reports, and if not, raise a flag to a user or otherwise send a message to the title company indicating to the title company that the appropriate title report(s) needs to be provided.

At operation 123, the escrow module instructs the borrower to review the title report and determine whether there are any demands to be ordered. The system can also be configured to extract loan data from the title report and validate that the borrower's stated payoff amount is within reason. This can be estimated, for example, based on the originally recorded loan amount, the date it was recorded and the amount of time since the inception of that debt. The escrow module can further be configured to submit an order for the demands. In some embodiments, the escrow module can provide the user interface to allow the borrower to order the demands directly through the escrow module. For example, the borrower may be prompted to enter the loan number, lender, and other information necessary to create a demand. The escrow module can be configured to use this information to generate a letter or other communication to the respective lender or lenders to request the payoff amounts. The escrow module can be configured to instruct the lender or lenders to send the demand(s) directly to the title company. Once the title company receives the demands, they can be scanned and electronic copy provided to the escrow module. The demands can also be used to draw the appropriate escrow documents.

At operation 127, the escrow module can be configured to check to ensure that all of the appropriate steps have been followed during the escrow process. For example, the escrow module can be configured to review the file to determine whether there are any open or flagged items that still remain uncompleted. If there are any open items, the escrow module can be configured to send the appropriate message for alert to the responsible party to completely open item. Additionally, the escrow module can be configured to generate a status report on a regular basis (e.g. daily, weekly, or otherwise) indicating the status of open and closed items in the escrow process. The status report can be provided to the consumer, the title company, the lender, or other appropriate entities informing them of the status and reminding responsible entities of open items fit have yet to be completed. Once the escrow module has verified that all items have been completed, the system can authorize the final loan documents to be delivered to the borrower.

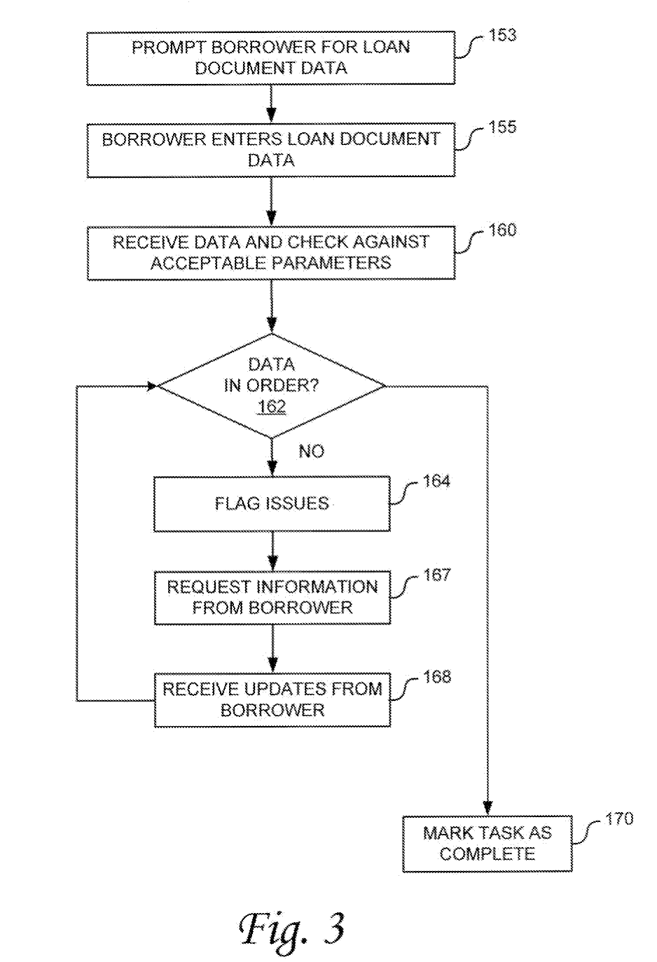

With the loan documents now available to the borrower, the system can coordinate gathering information from the borrower necessary to complete the loan documents. For example, in some embodiments, the system prepares a borrower's instruction that lists all of the charges from the new lender, payoff amounts for existing lenders, title fees, and so on. Additionally, the operation can also include gathering additional information from the borrower that will be needed to or useful for the loan approval process. FIG. 3 is an operational flow diagram illustrating an example process for completing the loan documents in accordance with one embodiment of the technology described herein. At operation 153, the escrow module prompts the user to provide the loan document data. For example, electronic forms or questionnaires can be provided to the borrower for the borrower to complete.

Once the borrower enters the requested loan document data, the escrow module receives the data and checks it against acceptable parameters for the data. This is illustrated at operations 155 and 160. For example, the system can check to ensure that all requested data was provided, that the data types entered match the data types of the corresponding fields, and so on. The system might also be configured to check other parameters such as, for example, the interest rate for verification (parameter for value), any per diem costs, the date the interest starts, and that points and appraisal fees are within an acceptable range.

If the data is in order, the escrow module marks the task as complete, allowing the process to continue to the next phase. This is illustrated at operations 162 and 170. If, on the other hand, the escrow module determines that one or more items of data are not correct, those items can be flagged. This is illustrated at operations 162 and 164. At operation 167, the escrow module requests corrected or updated information from the borrower in an attempt to address the flagged items. The request can include an indication of which item or items are incorrect (or possibly incorrect), and indicate to the borrower what the issue is with the item or items. The borrower can then either verify that the information is correct or obtain the correct information and update the form. Once the corrected information or verifications are provided by the borrower, at operation 168 they are received at the escrow module. If the information is now in order, the task is complete (operations 162, 170). If corrections are still required, operations 164, 167 and 168 are repeated.

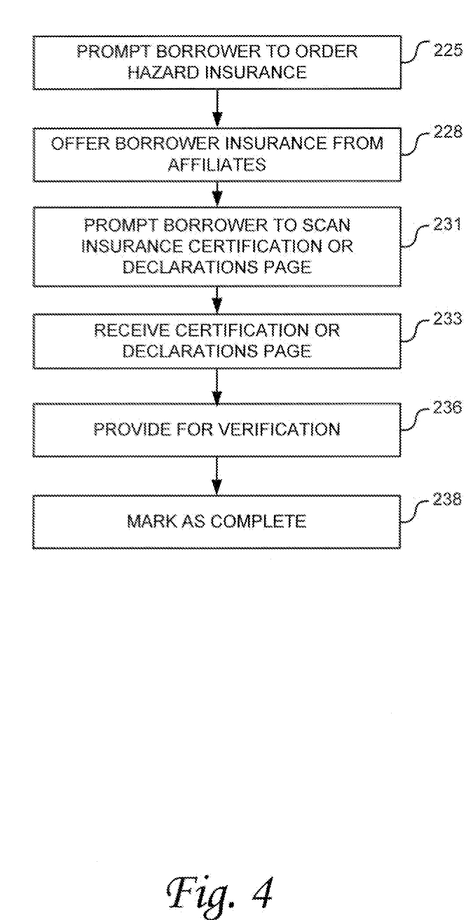

Most lenders require fire, flood, or other kind of hazard insurance for the subject property. Accordingly, in some embodiments, the escrow module can be configured to coordinate and verify that the property is properly insured in accordance with the lender's requirements. FIG. 4 is an operational flow diagram illustrating an example process for insurance verification in accordance with one embodiment of the technology described herein. Referring now to FIG. 4, at operation 225 the escrow module prompts the user to order the appropriate hazard insurance if none exists, or to provide verification of insurance if the property is already insured by the borrower (such as may be the case for a refinance). Because different lenders may have different requirements, the escrow module can be configured to provide insurance requirements on a lender-by-lender basis to the borrower. When loan documents are received from the lender, proof of homeowners' insurance (properly bearing the new loss payee's name and address) can be requested from the borrower. The borrower can obtain the appropriate certificate of insurance from his or her insurance carrier for the property.

In some embodiments, at operation 228, the escrow module can offer the buyer the opportunity to procure insurance through affiliates or other designated parties. Accordingly, the escrow module can be used as a tool to offer particular goods or services to the borrower during the escrow process. This can help drive revenues to affiliated businesses, or at a source of revenue from fees such as referral fees or click-through fees.

If the borrower has homeowners' insurance, or once the borrower has obtained the appropriate homeowners' insurance, the system prompts the user to provide proof of homeowners' insurance to the escrow module. This is illustrated at operation 231. For instance, the borrower can be prompted to scan and insurance certification or declaration page into an electronic form to be uploaded into the escrow module. As another example, the borrower can be provided the opportunity to fax the appropriate application using a fax cover sheet encoded to direct the fax document to the correct escrow files.

At operation 233, the escrow module receives the insurance verification and updates the file as indicating that the verification has been received. A notification can be provided to the lender or other designated party so that they can access the document and verify that it is correct and meets the lender's standards. This is illustrated at operation 236. At operation 238, the proof of insurance requirement can be marked as fulfilled or complete.

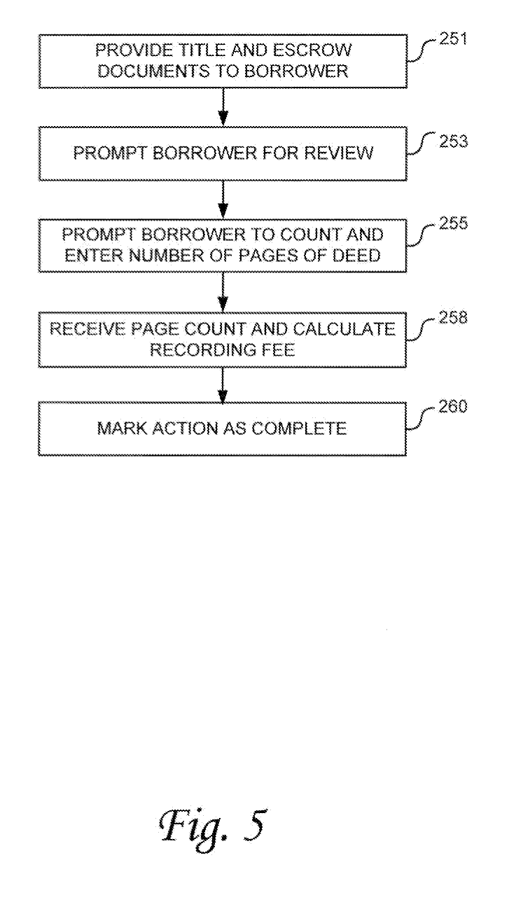

FIG. 5 is an operational flow diagram illustrating an example process for completing escrow documents in accordance with one embodiment of the technology described herein. Referring now to FIG. 5, at operation 251, title and escrow documents are provided to the borrower. These escrow documents are typically prepared by the escrow company in accordance with lender requirements and, in the case of purchase-money loans, in accordance with the purchase contract for the subject real property. PS for documents can be scanned or otherwise electronically provided to the escrow module and are associated with a particular file (e.g., by escrow number).

Operation 253, the escrow module prompts the borrower to review the escrow documents. Where escrow instructions or other documents require a borrower signature, the escrow module instructs the borrower regarding execution of the documents. In some embodiments, for this and other steps throughout the process, the escrow module can be configured to provide instructions to the user for the review and execution of documents and for the gathering of information required for the process. For example, videos, tutorials, or other instructional media can be made available to the borrower to assist the borrower in the process.

At operation 255, the escrow module prompts the borrower to count and enter the number of pages of the deed of trust or other document or documents to be recorded. The user enters the page count and at operation 258 the page count is received by the escrow module. The escrow module uses the page count to calculate the recording fee for recordation of the document or documents. Because recording fees can vary on a county-by-county or state-by-state basis, the escrow module can be configured to calculate the fees based on a fee schedule for the location in which the property is located. The fee information can be provided to the lender and the escrow agent to ensure that it is included, if appropriate, in the borrower's statement of closing costs. At operation 260, the action is marked as complete.

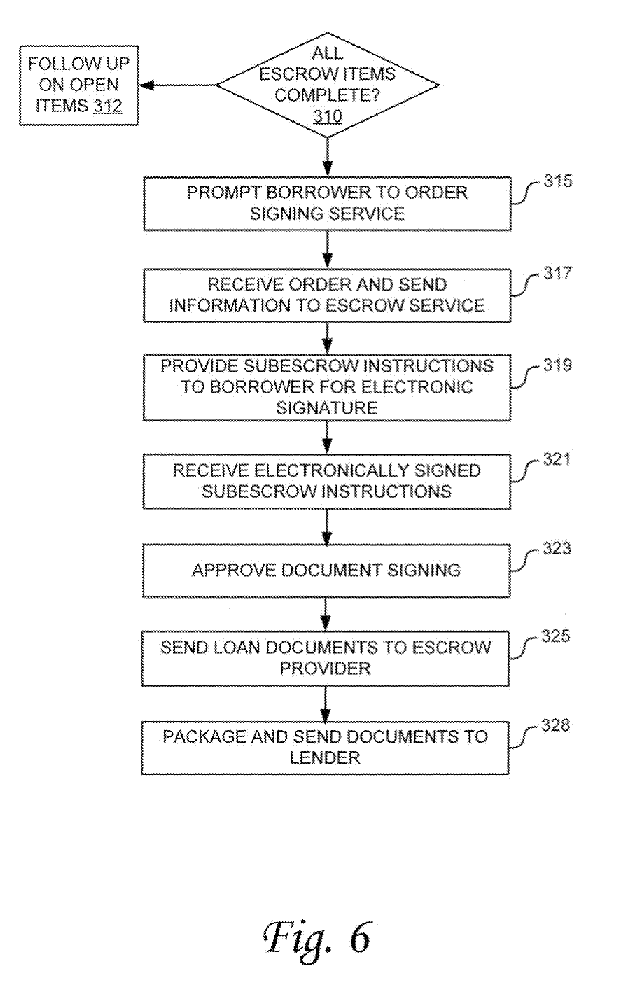

Once the necessary items are complete and all the information has been received from the borrower, the system can begin managing the process for executing the final loan documents. FIG. 6 is an operational flow diagram illustrating an example process for managing preparation and delivery of loan documents to the lender in accordance with one embodiment of the technology described herein. Referring now to FIG. 6, once all the escrow items are complete (or at least sufficiently complete to allow document preparation) the escrow module prompts the borrower to select a document signing service. This is illustrated by operations 310 and 315. At operation 317, the escrow module receives information on the signing service and provides information to the escrow provider so that the parties are all informed. In some embodiments, the escrow provider or lender may be the party that chooses a signing service. In other embodiments, a signing service is not used, and signing occurs at the offices of the lender or the escrow provider.

If there are open items, the escrow module carp follow up to attempt to close the open items as illustrated at operations 310 and 312. For example, the escrow module can provide information or alerts to the borrower, the escrow company, the lender, or others in an attempt to obtain missing or incomplete information, or to correct erroneous information.

At operation 319, the escrow module receives the sub escrow instructions from the escrow provider and provides the sub escrow instructions to the borrower for electronic signature. As described above, instructional information can also be provided to the borrower to guide the borrower in the signing process. At operation 321, the escrow module receives the signed sub escrow instructions. In some embodiments, an electronic signature is acceptable, while in other embodiments scanned or other electronic versions of a signed hard copy document are accepted.

At operation 323, the escrow module can verify the documents (e.g., verify that they have been properly executed). If the documents are not executed, the escrow module can prompt the borrower to correct the oversight. At operations 325 and 328, the loan documents can be packaged and sent to the escrow provider and the lender.

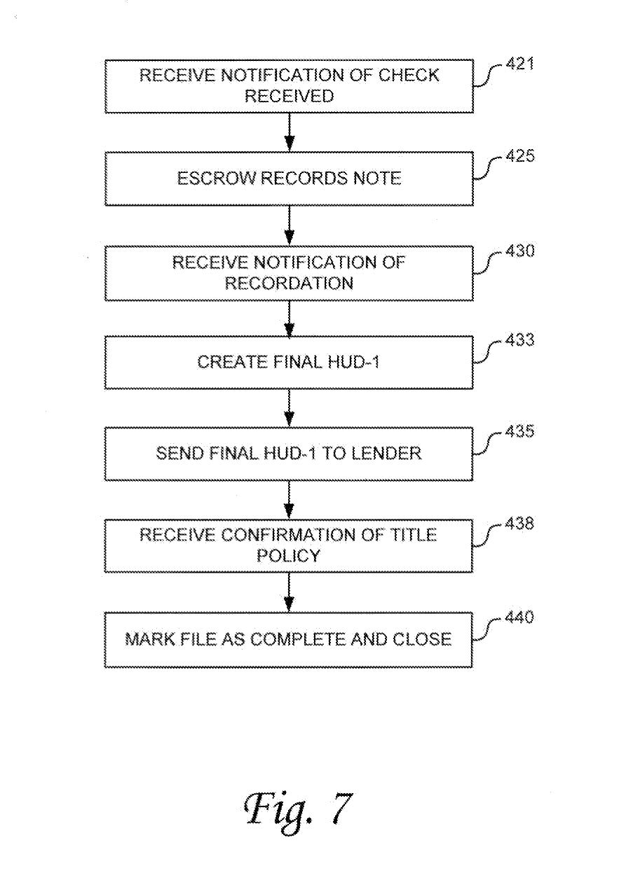

With the loan documents complete and executed, the loan can fund and recordable documents such as the grant deed and mortgage (where applicable) can be recorded. FIG. 7 is an operational flow diagram illustrating an example process for completing the refinance process in accordance with one embodiment of the technology described herein. Referring now to FIG. 7, at operation 421, the loan is funded and the escrow module receives a notification regarding the same. The escrow module can now flag that item as complete. After escrow records the note at the appropriate county offices, the escrow module receives notification of the recordation. This is illustrated at operations 425 and 430. The escrow module can also flag this item as complete.

At operation 433, the escrow module creates the final HUD-1 statement and sends it to the Lender at operation 435. At operation 438, the escrow module receives confirmation of the final title insurance policy. At operation 440, the escrow module checks to ensure that all items are complete and if so, marks the file as complete and closes it.

In various embodiments, as items are processed or coordinated by the escrow module, the escrow module can note open items and mark or flag them as complete as they are completed. Accordingly, in some embodiments, the escrow module can keep track of open items and address them. For example, the escrow module might follow up with the borrower or other parties to complete action items or obtain missing information. As another example, the escrow module might be configured to check open item statuses and allow advancement to a next stage only after all prerequisites are met.

Because different service providers and affiliates may have different requirements, the escrow module can be configured to tailor its services based on the particular requirements of the individual service providers use for a given escrow process. For example, certain lenders may require that certain loan documents be used for the closing of their loans, or they may have a particular set of instructions for insurance on the property, loan-to-value ratios, and so on. In various embodiments, particular requirements can be provided to the escrow module in the escrow module can be configured to track these requirements based on the service provider or providers involved with a particular loan. Accordingly, information sent to and requested from a borrower can be tailored to the specific service provider requirements, as can the verifications performed by the escrow module on the information received.

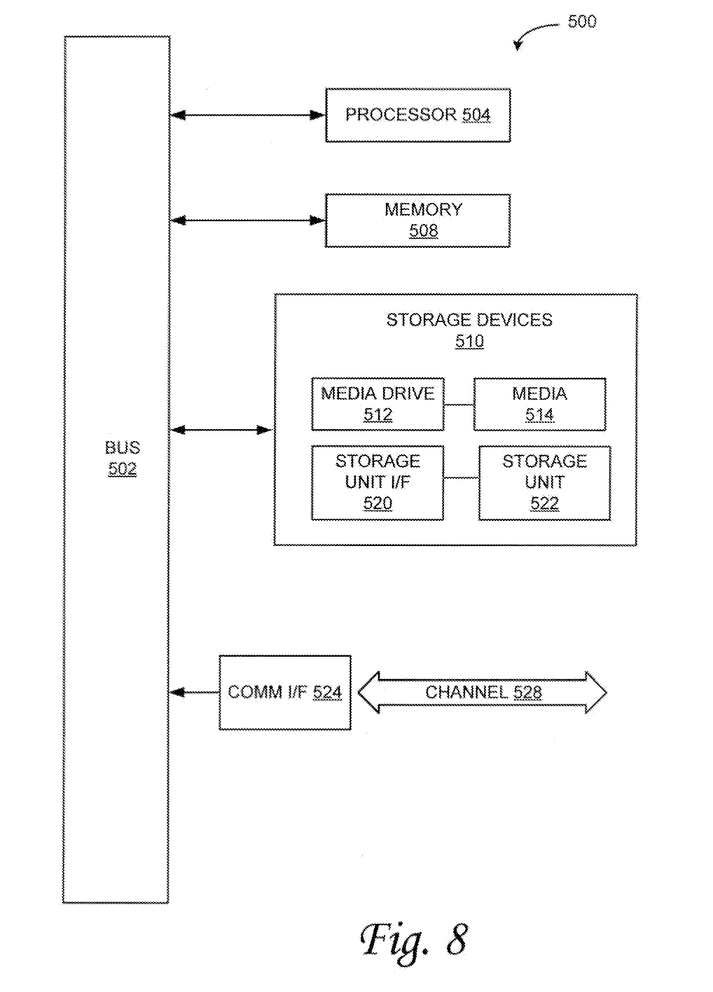

As used herein, the term module might describe a given unit of functionality that can be performed accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the technology using other computing modules or architectures.

Referring now to FIG. 8, computing module 800 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 804. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 824 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A non-transitory computer readable medium comprising executable instructions, the executable instructions being executable by a processor in a computing device to perform a method for providing self-service escrow to a borrower, the method comprising:
providing a user interface to a borrower the user interface configured to accept input by which the borrower initiates a borrower-driven self-service escrow;
providing the borrower with a listing of data items required to allow the borrower-driven self-service escrow process to proceed;
receiving requested information from the borrower;
keeping track of complete and incomplete data items to be used in the borrower-driven self-service escrow process;
providing received information to a verification entity to confirm accuracy of received information; and
determining based on at least the received information whether all escrow items are complete, and if so, informing the escrow company and the lender that the loan can proceed to closing.

2. The non-transitory computer readable medium recited in claim 1, wherein the method further comprises:
prompting the borrower to designate preferred lenders; and
tailoring the list of data items requested to at least match the information required by the borrower designated preferred lenders.

3. The non-transitory computer readable medium recited in claim 1, wherein the method further comprises checking a received data item against predetermined parameters to determine whether the received data item is an acceptable data item.

4. The non-transitory computer readable medium recited in claim 3, wherein the method further comprises flagging unacceptable data items discovered during checking, and requesting the borrower to correct any unacceptable data items.

5. The non-transitory computer readable medium recited in claim 4, wherein the method further comprises sending at least one reminder to the borrower to correct unacceptable data items.

6. The non-transitory computer readable medium recited in claim 1, wherein the method further comprises:
sending acceptable data items to at least one third-party verification source to provide verification of at least one unverified item;
flagging unverified data items;
monitoring verification status of data items, and ensuring that unverified data items remain flagged as unverified until such time as the verification is completed;

7. The non-transitory computer readable medium recited in claim 6, wherein the method further comprises sending at least one reminder to the appropriate third-party verification source.

8. The non-transitory computer readable medium recited in claim 1, wherein the method further comprises generating and providing a regular status report indicating any incomplete, unacceptable, or unverified data items to a party to the transaction.

9. The non-transitory computer readable medium recited in claim 1, wherein the method further comprises requesting and receiving electronic verification of insurance from the borrower, and updating the borrower's account to reflect that verification has been received.

10. The non-transitory computer readable medium recited in claim 1, wherein the method further comprises prompting the borrower to order insurance for a property being used to secure a loan.

11. The non-transitory computer readable medium recited in claim 10, wherein the method further comprises providing a listing of insurance providers through whom the borrower may procure insurance.

12. The non-transitory computer readable medium recited in claim 1, wherein the method further comprises receiving an electronic copy of proof of insurance from the borrower.

13. The non-transitory computer readable medium recited in claim 1, wherein the method further comprises using the received information to estimate likely terms of the loan arrangement, and providing the borrower a prediction of what terms they might be able to obtain if they were to proceed.

14. The non-transitory computer readable medium recited in claim 1, wherein the method further comprises providing to the borrower a listing of title companies that may perform title services in conjunction with real-property financing.

15. The non-transitory computer readable medium recited in claim 6, wherein the method further comprises opening sub-escrow order and title order, and submitting a request to a title company including the sub-escrow order and the title order.

16. The non-transitory computer readable medium recited in claim 15, wherein the method further comprises receiving information back from the title company providing a determination of whether or not the submitted request will qualify for the self-service escrow process, and the reasons for the determination.

17. The non-transitory computer readable medium recited in claim 6, wherein the method further comprises notifying the lender and/or other designated parties that they may access the received information to verify that the received information meets the lender's standards.

18. The non-transitory computer readable medium recited in claim 17, wherein the method further comprises receiving lender verification, and prompting the borrower to select a document signing service for executing the final loan documents.

19. The non-transitory computer readable medium recited in claim 11, wherein the method further comprises offering further goods or services to a borrower during the self-service escrow process.

20. The non-transitory computer readable medium recited in claim 6, wherein the method further comprises providing escrow documents to the borrower for review, and prompting the borrower to count and enter a number of pages of a deed document.

21. The non-transitory computer readable medium recited in claim 2, wherein the method further comprises automatically calculating a recording fee based on the count of the number of pages of the deed document.

22. The non-transitory computer readable medium recited in claim 18, wherein the method further comprises:
receiving notification that the loan is funded;
receiving notification that the escrow has recorded the note at the appropriate county office; and
flagging the corresponding items as complete.

23. The non-transitory computer readable medium recited in claim 18, wherein the method further comprises creating the final HUD-1 statement and sending it to the lender.

24. The non-transitory computer readable medium recited in claim 15, wherein the method further comprises:
receiving confirmation of the final title insurance policy;
checking to ensure that all items are complete, and if so, flagging the file as complete; and
closing the file.

25. The non-transitory computer readable medium recited in claim 1, wherein the method further comprises providing the borrower with the option of creating an account having a user ID and password.

26. The non-transitory computer readable medium recited in claim 1, wherein the method further comprises compiling escrow documents for assembly into a reference packet for the parties.

27. A computer system for facilitating self-service escrow, comprising:
a processor;
a memory connected to the processor; and
a computer readable medium having instructions embedded therein, the instructions configured to cause the processor to perform the operations of:
providing a user interface to a borrower the user interface configured to accept input by which the borrower initiates a borrower-driven self-service escrow;
providing the borrower with a listing of data items required to allow the borrower-driven self-service escrow process to proceed;
receiving requested information from the borrower;
keeping track of complete and incomplete data items to be used in the borrower-driven self-service escrow process;
providing received information to at least one verification entity to confirm accuracy of received information;
determining based on at least the received information whether all escrow items are complete, and if so, informing the escrow company and the lender that the loan can proceed to closing.

28. The computer system of claim 27, wherein the program instructions are further configured to cause a computer system to:
prompt the borrower to designate preferred lenders;
tailor the list of data items requested to at least match the information required by the borrower designated preferred lenders.

29. The computer system of claim 27, wherein the program instructions are further configured to cause a computer system to check a received data item against predetermined parameters to determine whether the received data item is an acceptable data item.

30. The computer system of claim 27, wherein the program instructions are further configured to cause a computer system to flag unacceptable data items discovered during checking, and requesting the borrower to correct any unacceptable data items.

31. The computer system of claim 30, wherein the program instructions are further configured to cause a computer system to send at least one reminder to the borrower to correct unacceptable data items.

32. The computer system of claim 30, wherein the program instructions are further configured to cause a computer system to:
send acceptable data items to at least one third-party verification source to provide verification of at least one unverified item;
flag unverified data items;
monitor verification status of data items, and ensure that unverified data items remain flagged as unverified until such time as the verification is completed;

33. The computer system of claim 32, wherein the program instructions are further configured to cause a computer system to send at least one reminder to the appropriate third-party verification source.

34. The computer system of claim 27, wherein the program instructions are further configured to cause a computer system to generate and provide a regular status report indicating any incomplete, unacceptable, or unverified data items to a party to the transaction.

35. The computer system of claim 27, wherein the program instructions are further configured to cause a computer system to request and receive electronic verification of insurance from the borrower, and update the borrower's account to reflect that verification has been received.

36. The computer system of claim 27, wherein the program instructions are further configured to cause a computer system to prompt the borrower to order insurance for a property being used to secure a loan.

37. The computer system of claim 27, wherein the program instructions are further configured to cause a computer system to provide a listing of insurance providers to the borrower through whom they may procure insurance.

38. The computer system of claim 37, wherein the program instructions are further configured to cause a computer system to receive an electronic copy of proof of insurance from the borrower.

39. The computer system of claim 27, wherein the program instructions are further configured to cause a computer system to use the received information to estimate likely terms of the loan arrangement, and provide the borrower a prediction of what terms they might be able to obtain if they were to proceed.

40. The computer system of claim 27, wherein the program instructions are further configured to cause a computer system to provide to the borrower a listing of title companies that may perform title services in conjunction with real-property financing.

41. The computer system of claim 27, wherein the program instructions are further configured to cause a computer system to open sub-escrow order and title order, and submit a request to title company including the sub-escrow order and the title order.

42. The computer system of claim 41, wherein the program instructions are further configured to cause a computer system to receive information back from the title company providing a determination of whether or not the submitted request will qualify for the self-service escrow process, and the reasons for the determination.

43. The computer system of claim 27, wherein the program instructions are further configured to cause a computer system to notify the lender and/or other designated parties that they may access the received information to verify that the received information meets the lender's standards.

44. The computer system of claim 43, wherein the program instructions are further configured to cause a computer system to receive lender verification, and prompting the borrower to select a document signing service for executing the final loan documents.

45. The computer system of claim 27, wherein the program instructions are further configured to cause a computer system to offer further goods or services to a borrower during the self-service escrow process.

46. The computer system of claim 27, wherein the program instructions are further configured to cause a computer system to provide escrow documents to the borrower for review, and prompting the borrower to count and enter a number of pages of a deed document.

47. The computer system of claim 46, wherein the program instructions are further configured to cause a computer system to automatically calculate a recording fee based on the count of the number of pages of the deed document.

48. The computer system of claim 27, wherein the program instructions are further configured to cause a computer system to:
receive notification that the loan is funded;
receive notification that the escrow has recorded the note at the appropriate county office; and
flag the corresponding items as complete.

49. The computer system of claim 44, wherein the program instructions are further configured to cause a computer system to create the final HUD-1 statement and send it to the lender.

50. The computer system of claim 27, wherein the program instructions are further configured to cause a computer system to provide the borrower with the option of creating an account having a user ID and password.

51. The computer system of claim 27, wherein the program instructions are further configured to cause a computer system to:
receive confirmation of the final title insurance policy;
check to ensure that all items are complete, and if so, flag the file as complete; and close the file.

52. The computer system of claim 27, wherein the program instructions are further configured to cause a computer system to compile escrow documents for assembly into a reference packet for the parties.
